(19) United States
(12) Patent Application Publication
(10) Pub. No.: US 2015/0193621 A1
(43) Pub. Date: Jul. 9, 2015

(54) SECURITY SCAN USING ENTITY HISTORY

(71) Applicant: INTERNATIONAL BUSINESS MACHINES CORPORATION, Armonk, NY (US)

(72) Inventors: Mohammadreza Barouni Ebrahimi, Ottawa (CA); Paul Ionescu, Ottawa (CA); Iosif V. Onut, Ottawa (CA)

(21) Appl. No.: 14/591,283

(22) Filed: Jan. 7, 2015

(30) Foreign Application Priority Data
Jan. 9, 2014 (CA) 2838908

(51) Int. Cl. G06F 21/57; H04L 29/06

(52) U.S. Cl. CPC G06F 21/577; H04L 63/1433; G06F 2221/034

(57) ABSTRACT

An illustrative embodiment of a computer-implemented process for security scanning using entity history responsive to a determination that a set of vulnerabilities exist for a selected security entity, tests the selected entity using a vulnerability set selected from an issues history and responsive to a determination that all vulnerabilities are not found, determining whether more vulnerabilities sets exist. Responsive to a determination that more vulnerabilities sets exist, obtains a next set of vulnerabilities and tests the selected security entity using another vulnerability set selected from the issues history. Responsive to a determination that a set of vulnerabilities does not exist for the selected security entity, performs a full scan of the selected security entity and responsive to a determination that security issues are identified, records the security issues identified in the issues history.

### BACKGROUND

This disclosure relates generally to software security in a data processing system and more specifically to application security scanning using entity history in the data processing system.

Testing a webpage for security vulnerabilities is a tedious and time-consuming task due to a requirement to send a number of security tests to a server for each security entity contained on the webpage. A security entity comprises a variable element of the webpage a client can modify, for example, parameters and cookies.

Black-box testing, also referred to as dynamic analysis, is a methodology in which a crawler (for example a hacker or security auditor) performs a brute force attack in attempt to mutate values of the variable elements of the webpage to identify a security vulnerability reflected in a response from a server. The number of security tests sent by an automated program to the security entity can be in the thousands, because vulnerabilities for the variable elements of the webpage can be exploited in a number of various ways.

A typical website containing hundreds of pages, each with tens of security entities, may readily lead one skilled in the art to a conclusion that attempting all possible mutations may not be a reasonable solution or may require a significant amount of time. Current solutions typically either send all mutations on all security entries, or send a subset of those mutations to the security entries.

With reference to FIG. 1 a flowchart of a current process for a security scan of application pages is presented. Each page of a particular application is scanned to identify security entities contained within a page. A list of identified security entities is tested using a brute force technique, referred to as a full scan of the security entity. Vulnerabilities found during the full scan are saved as output of the current process. Performing the full scan of each entity is typically a bottleneck in the current process.

### SUMMARY

An embodiment of the present invention provides a computer-implemented method for security scanning using entity history. The computer-implemented method comprises: determining, by one or more processors, whether a set of vulnerabilities exist for a selected security entity; responsive to a determination that the set of vulnerabilities exist for the selected security entity, testing, by one or more processors, the selected security entity using a vulnerability set selected from an issues history; determining, by one or more processors, whether all vulnerabilities are found; responsive to a determination that all vulnerabilities are not found, determining, by one or more processors, whether more vulnerabilities sets exist; responsive to a determination that more vulnerabilities sets exist, obtaining, by one or more processors, a next set of vulnerabilities; testing, by one or more processors, the selected security entity using another vulnerability set selected from the issues history; responsive to a determination that a set of vulnerabilities does not exist for the selected security entity, performing, by one or more processors, a full scan of the selected security entity; determining, by one or more processors, whether security issues are identified; and responsive to a determination that security issues are identified, recording, by one or more processors, the security issues identified in the issues history.

An embodiment of the present invention provides a computer program product for security scanning using entity history. The computer program product comprises a computer readable storage device containing computer executable program code stored thereon. The computer executable program code comprises: computer executable program code for determining whether a set of vulnerabilities exist for a selected security entity; computer executable program code that responds to a determination that the set of vulnerabilities exist for the selected security entity by testing the selected entity using a vulnerability set selected from an issues history; computer executable program code for determining whether all vulnerabilities are found; computer executable program code that responds to a determination that all vulnerabilities are not found by determining whether more vulnerabilities sets exist; computer executable program code that responds to a determination that more vulnerabilities sets exist by obtaining a next set of vulnerabilities; computer executable program code for testing the selected security entity using another vulnerability set selected from the issues history; computer executable program code that responds to a determination that a set of vulnerabilities does not exist for a selected security entity by performing a full scan of the selected security entity; computer executable program code for determining whether security issues are identified; and computer executable program code that responds to a determination that security issues are identified by recording the security issues identified in the issues history.

An embodiment of the present invention provides a computer system for security scanning using entity history comprising: one or more computer processors; one or more computer readable storage medium; computer executable program code stored on the computer readable storage medium for execution by at least one of the one or more processors. The computer executable program code comprises: computer executable program code for determining whether a set of vulnerabilities exist for a selected security entity; computer executable program code that responds to a determination that the set of vulnerabilities exist for the selected security entity by testing the selected entity using a vulnerability set selected from an issues history; computer executable program code for determining whether all vulnerabilities are found; computer executable program code that responds to a determination that all vulnerabilities are not found by determining whether more vulnerabilities sets exist; computer executable program code that responds to a determination that more vulnerabilities sets exist by obtaining a next set of vulnerabilities; computer executable program code for testing the selected security entity using another vulnerability set selected from the issues history; computer executable program code that responds to a determination that a set of vulnerabilities does not exist for a selected security entity by performing a full scan of the selected security entity; computer executable program code for determining whether security issues are identified; and computer executable program code that responds to a determination that security issues are identified by recording the security issues identified in the issues history.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a flowchart of a current typical security scanning process;

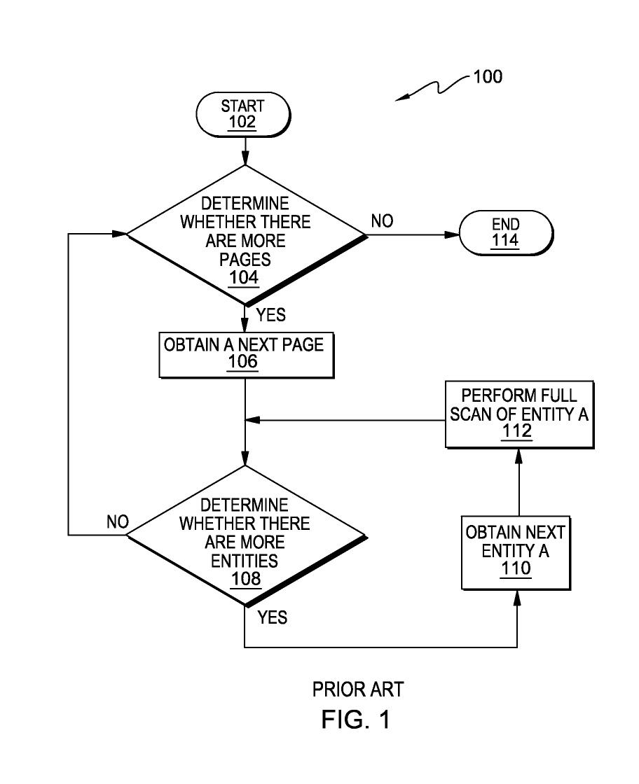

FIG. 2 is a block diagram of an exemplary network data processing system operable for various embodiments of the disclosure;

FIG. 3 is a block diagram of an exemplary data processing system operable for various embodiments of the disclosure;

FIG. 4 is a block diagram representation of a security scan system operable for various embodiments of the disclosure;

FIG. 5 is a flowchart of a process using the security scan system of FIG. 3 in accordance with one embodiment of the disclosure; and

FIG. 6 is a flowchart of a process using the security scan system of FIG. 3 in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer-readable data storage devices may be utilized. A computer-readable data storage device may be, for example, but not limited to, an electronic, magnetic, optical, or semiconductor system, apparatus, or device, or any suitable combination of the foregoing, but does not encompass propagation media. More specific examples (a non-exhaustive list) of the computer-readable data storage devices would include the following: a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device or any suitable combination of the foregoing, but does not encompass propagation media. In the context of this document, a computer-readable data storage device may be any tangible device that can store a program for use by or in connection with an instruction execution system, apparatus, or device. A computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code for carrying out operations for aspects of the present disclosure may be written in any combination of one or more programming languages, including an object oriented programming language such as Java®, Smalltalk, C++, or the like and conventional procedural programming languages, such as the “C” programming language or similar programming languages. Java and all Java-based trademarks and logos are trademarks of Oracle Corporation, and/or its affiliates, in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus, (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable data storage device that can direct a computer or other programmable data processing apparatus to function in a particular manner, such that the instructions stored in the computer readable data storage device produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

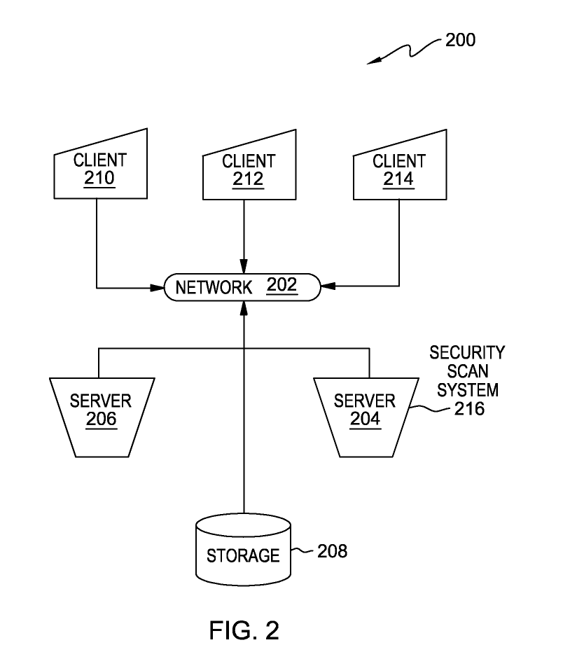

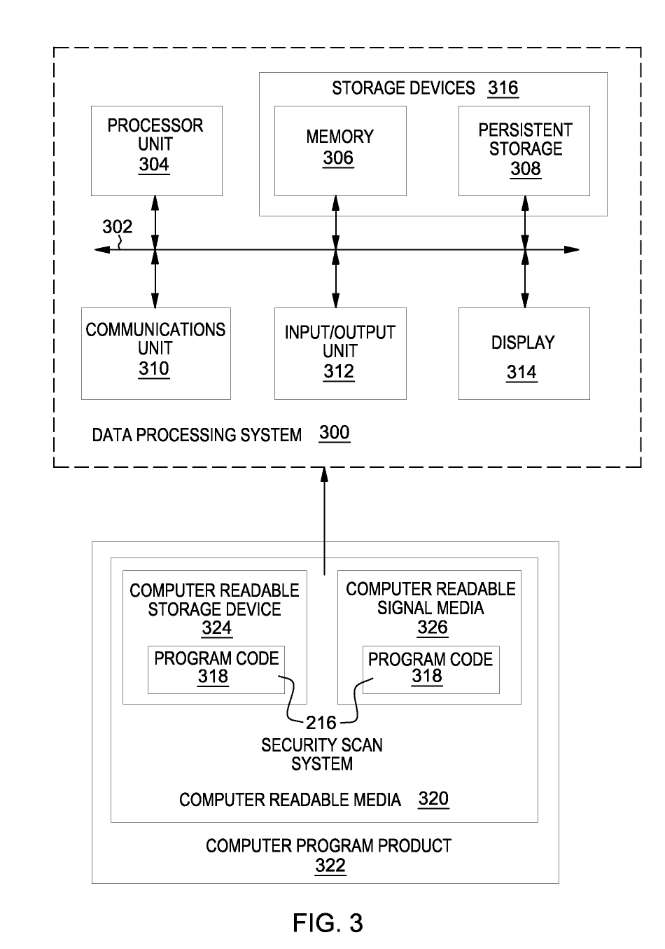

With reference now to the figures and in particular with reference to FIGS. 2-3, exemplary diagrams of data processing environments are provided in which illustrative embodiments may be implemented. It should be appreciated that FIGS. 2-3 are only exemplary and are not intended to assert or imply any limitation with regard to the environments in which different embodiments may be implemented. Many modifications to the depicted environments may be made.

FIG. 2 depicts a pictorial representation of a network of data processing systems in which illustrative embodiments may be implemented. Network data processing system 200 is a network of computers in which the illustrative embodiments may be implemented. Network data processing system 200 contains network 202, which is the medium used to provide communications links between various devices and computers connected together within network data processing system 200. Network 202 may include connections, such as wire, wireless communication links, or fiber optic cables.

In the depicted example, server 204 and server 206 connect to network 202 along with storage unit 208. In addition, clients 210, 212, and 214 connect to network 202. Clients 210, 212, and 214 may be, for example, personal computers or network computers. In the depicted example, server 204 provides data, such as boot files, operating system images, and applications to clients 210, 212, and 214. Clients 210, 212, and 214 are clients to server 204 in this example. Network data processing system 200 may include additional servers, clients, and other devices not shown.

In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the different illustrative embodiments.

With reference to FIG. 3 a block diagram of an exemplary data processing system operable for various embodiments of the disclosure is presented. In this illustrative example, data processing system 300 includes communications fabric 302, which provides communications between processor unit 304, memory 306, persistent storage 308, communications unit 310, input/output (I/O) unit 312, and display 314.

Processor unit 304 serves to execute instructions for software that may be loaded into memory 306. Processor unit 304 may be a set of one or more processors or may be a multi-processor core, depending on the particular implementation. Further, processor unit 304 may be implemented using one or more heterogeneous processor systems in which a main processor is present with secondary processors on a single chip. As another illustrative example, processor unit 304 may be a symmetric multi-processor system containing multiple processors of the same type.

Memory 306 and persistent storage 308 are examples of storage devices 316. A storage device is any piece of hardware that is capable of storing information, such as, for example without limitation, data, program code in functional form, and/or other suitable information either on a temporary basis and/or a permanent basis. Memory 306, in these examples, may be, for example, a random access memory or any other suitable volatile or non-volatile storage device. Persistent storage 308 may take various forms depending on the particular implementation. For example, persistent storage 308 may contain one or more components or devices. For example, persistent storage 308 may be a hard drive, a flash memory, a rewritable optical disk, a rewritable magnetic tape, or some combination of the above. The media used by persistent storage 308 also may be removable. For example, a removable hard drive may be used for persistent storage 308.

Communications unit 310, in these examples, provides for communications with other data processing systems or devices. In these examples, communications unit 310 is a network interface card. Communications unit 310 may provide communications through the use of either or both physical and wireless communications links.

Input/output unit 312 allows for input and output of data with other devices that may be connected to data processing system 300. For example, input/output unit 312 may provide a connection for user input through a keyboard, a mouse, and/or some other suitable input device. Further, input/output unit 312 may send output to a printer. Display 314 provides a mechanism to display information to a user.

Instructions for the operating system, applications and/or programs may be located in storage devices 316, which are in communication with processor unit 304 through communications fabric 302. In these illustrative examples the instructions are in a functional form on persistent storage 308. These instructions may be loaded into memory 306 for execution by processor unit 304. The processes of the different embodiments may be performed by processor unit 304 using computer-implemented instructions, which may be located in a memory, such as memory 306.

These instructions are referred to as program code, computer usable program code, or computer readable program code that may be read and executed by a processor in processor unit 304. The program code in the different embodiments may be embodied on different physical or tangible computer readable storage media, such as memory 306 or persistent storage 308.

Program code 318 is located in a functional form on computer readable media 320 that is selectively removable and may be loaded onto or transferred to data processing system 300 for execution by processor unit 304. Program code 318 and computer readable media 320 form computer program product 322 containing security scan system 216 in these examples. In one example, computer readable media 320 may be in a tangible form, for example, an optical or magnetic disc that is inserted or placed into a drive or other device that is part of persistent storage 308 for transfer onto a storage device, such as a hard drive that is part of persistent storage 308. In a tangible form, computer readable media 320 also may take the form of a persistent storage, such as a hard drive, a thumb drive, or a flash memory that is connected to data processing system 300. The tangible form of computer readable media 320 is also referred to as computer recordable storage media or computer readable storage device 324 and does not encompass a propagation medium and is therefore distinct from computer readable signal media 326. In some instances, computer readable media 320 may not be removable.

Alternatively, program code 318 may be transferred to data processing system 300 from computer readable media 320 using computer readable signal media 326 through a communications link to communications unit 310 and/or through a connection to input/output unit 312. The communications link and/or the connection may be physical or wireless in the illustrative examples.

In some illustrative embodiments, program code 318 may be downloaded over a network to persistent storage 308 from another device or data processing system for use within data processing system 300. For instance, program code stored in a computer readable data storage device in a server data processing system may be downloaded over a network from the server to data processing system 300. The data processing system providing program code 318 may be a server computer, a client computer, or some other device capable of storing and transmitting program code 318.

Using data processing system 300 of FIG. 3 as an example, a computer-implemented method for security scanning using entity history is presented. Processor unit 304 determines whether a set of vulnerabilities exist for a selected security entity and responsive to a determination that the set of vulnerabilities exist for the selected security entity, tests the selected security entity using a vulnerability set selected from an issues history.

Processor unit 304 further determines whether all vulnerabilities are found and responsive to a determination that all vulnerabilities are not found, determines whether more vulnerabilities sets exist. Responsive to a determination that more vulnerabilities sets exist, processor unit 304 obtains a next set of vulnerabilities and tests the selected security entity using another vulnerability set selected from the issues history.

Responsive to a determination that a set of vulnerabilities does not exist for the selected security entity, processor unit 304 performs a full scan of the selected security entity and determines whether security issues are identified. Responsive to a determination that security issues are identified, processor unit 304 records the security issues identified in the issues history.

An embodiment of the disclosed method for application security scanning comprises in response to receiving a web page, identifying an entity on the web page and determining whether there is a vulnerability set associated with the entity identified recorded in a history. Responsive to a determination that there is the vulnerability set associated with the entity identified recorded in the history, selecting a first unchecked vulnerability set and sending all security tests used in the selected vulnerability set to discover vulnerabilities.

Responsive to a determination that all vulnerabilities are not found, selecting a next vulnerability set for the entity identified and determining whether there is one of a full match of vulnerabilities or all vulnerability sets have been considered. Responsive to a determination that all vulnerability sets have been considered and no match found, performing a full scan on the entity identified. Responsive to a determination that there is a vulnerability set identified for the entity identified saving the vulnerability set identified in the history. Responsive to a determination that all vulnerabilities are found in the selected vulnerability set, selecting a next entity wherein testing of the entity identified with the selected vulnerability set is complete.

Responsive to a determination that there is no vulnerability set associated with the entity identified recorded in the history, performing a full scan of the entity. Responsive to a determination that there is a vulnerability set identified for the entity identified saving the vulnerability set identified in the history.

The current disclosure accordingly provides a method of optimizing a process of testing security entities by exploiting knowledge obtained of a similarity security entities that repeat across pages. When a security entity appears on more than one web page, there is an increased probability the security entity serves the same functionality and will likely exercise a common code path. For example, a security entity comprising a parameter articleName is likely to save the same purpose on the shopping cart and on the order details page. A possibility exists though the parameter value will go through a different code path on the shopping cart page than on the order details page in which case the following heuristic is used: when a security entity is fully tested on one page, and the result of that test is a set of vulnerabilities, there is a high probability other occurrences of the instant security entity on other pages will produce the same set of vulnerabilities.

Therefore, once a security entity is fully tested and found vulnerable on a particular page, the obtained information is stored and used when assessing any other occurrence of the same security entity on any other page. The obtained information is used to validate the same set of vulnerabilities exist on the occurrence of newfound entities. When this condition holds, sending all the possible security tests is not needed saving time and resources. Embodiments of the disclosed process typically improve the performance of a security scan with minimal impact on the accuracy of the scan.

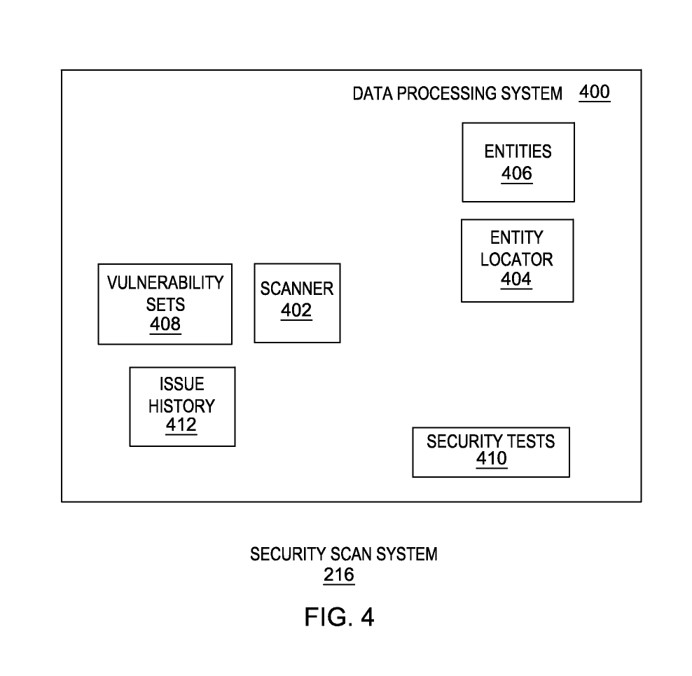

With reference to FIG. 4 a block diagram of a security scan system operable for various embodiments of the disclosure is presented. Security scan system 216 as depicted is an example of a set of functional components in an illustrative embodiment of the disclosure. Security scan system 216 may be implemented with more or less components than depicted in the current example without loss of function. For example, components as illustrated may be combined into a monolithic structure or may be further decomposed and distributed across systems while still providing the existing capability.

Security scan system 216 includes a number of functional components comprising scanner 402, entity locator 404, entities 406, vulnerability sets 408, security tests 410 and issue history 412. Security scan system 216 leverages the underlying support of data processing system 400, which is an example of server 204 of network data processing system 200 of FIG. 2 or data processing system 300 of FIG. 3.

Scanner 402 provides a capability of performing an analysis of one or more target web pages representative of a software application or service site. Scanner 402 includes a crawling capability to traverse the various segments of each page of the one or more target web pages according to a predetermined policy.

Entity locator 404 provides a capability to examine elements of each page of the one or more target web pages to identify entities 406 comprising variables of a respective webpage a client can modify. For example, in one instance entity locator 404 provides a capability of pattern matching to identify any one of a predetermined set of entities. The variables comprising entities 406 are elements including parameters and cookies which may be provided with corresponding values by a user or on behalf of a user during use of the one or more target web pages.

Vulnerability sets 408 represent a number of collections of vulnerability issues, each of which comprise a list of security issues located in a page of the one or more target web pages for a particular entity. The particular entity can therefore have one or more security issue associated. Vulnerability sets 408 are therefore one or more vulnerability set.

Security tests 410 represent one or code portions for exercising a particular aspect associated with security of one or more entities. For example, a security test may be directed to determine whether a variable on a target webpage is within a permitted range.

Issue history 412 is a data structure containing a list of all vulnerability sets 408 for each of entities 406 for which vulnerabilities were found during a scan by scanner 402. Issue history 412 is initialized as an empty data structure at the start of a scan, and is gradually populated during the scanning process with vulnerabilities found.

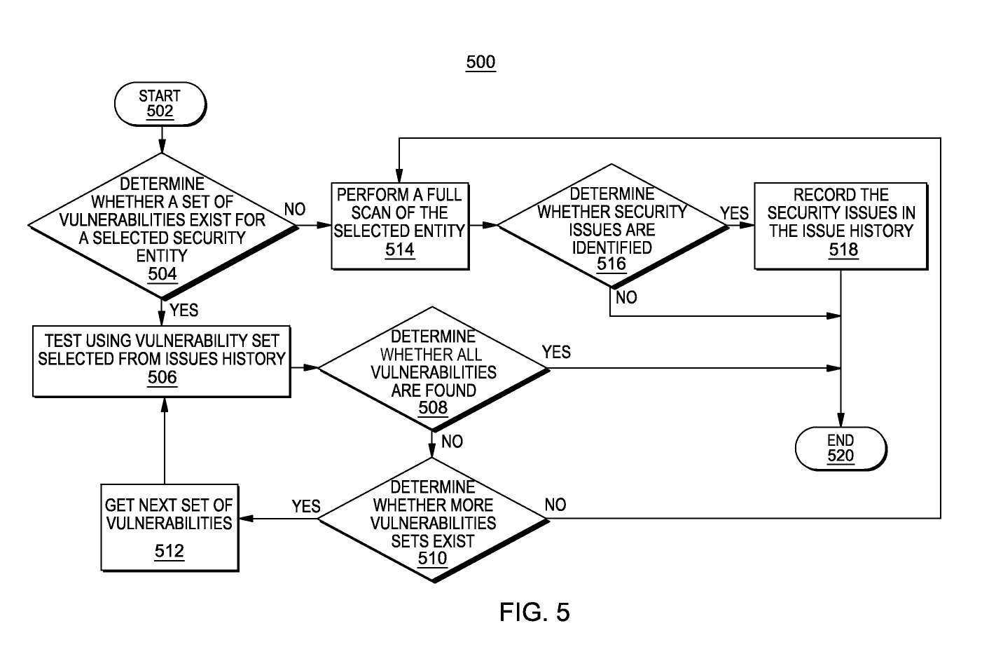

With reference to FIG. 5 a flowchart of a process using the security scan system of FIG. 3 in accordance with one embodiment of the disclosure is presented. Process 500 is an example of a security scan of an application using security scan system 216 of FIG. 4.

Process 500 begins (step 502) and determines whether a set of vulnerabilities exist for a selected security entity (step 504). The determination uses a data structure containing an issues history data set containing vulnerability information representative of previously identified security issues. When a security entity is fully tested on one page, and the result of that test is a set of vulnerabilities, there is a high probability other occurrences of the same security entity located on this page and other pages will produce the same set of vulnerabilities. A reduction in testing, comprising processing and other resources typically leads to an speed increase once a security entity is fully tested and found vulnerable on a page, because the prior information is saved and used when assessing other occurrence of the same security entity on any other page. Corresponding tests are invoked using the saved information in the issues history.

Responsive to a determination that a set of vulnerabilities exist for a selected security entity (step 504, YES branch), process 500 tests (the selected entity) using a vulnerability set selected from an issues history (step 506). When the first instance of a selected security entity is tested a first unchecked set of vulnerabilities is selected as testing input. Subsequent tests use remaining vulnerability sets associated with the selected security entity, when available. Testing sends all the security tests used in the particular vulnerability set to discover specific vulnerabilities for the selected entity.

Process 500 determines whether all vulnerabilities are found (step 508). The determination involves identifying whether the tests exposed vulnerabilities associated with the selected security entity. Responsive to a determination that all vulnerabilities are found (step 508, YES branch), process 500 terminates (step 520).

Responsive to a determination that all vulnerabilities are not found (step 508, NO branch), process 500, determines whether more vulnerabilities sets exist (step 510). Responsive to a determination that more vulnerabilities sets exist (step 510, YES branch), process 500 gets a next set of vulnerabilities (step 512) and returns to perform step 506 as before. Responsive to a determination that no more vulnerabilities sets exist (step 510, NO branch), process 500 proceeds to step 514.

Returning to step 504, responsive to a determination that a set of vulnerabilities does not exist for a selected security entity (step 504, NO branch), process 500 scans the security entity (step 514). A full scan is necessarily performed to identify security issues associated with the security entity. Process 500 determines whether security issues are identified (step 516). Responsive to a determination that security issues are identified (step 516, YES branch), process 500 records the security issues in an issue history (step 518) and terminates thereafter (step 520). Responsive to a determination that security issues are not identified (step 516, NO branch), process 500 terminates thereafter (step 520).

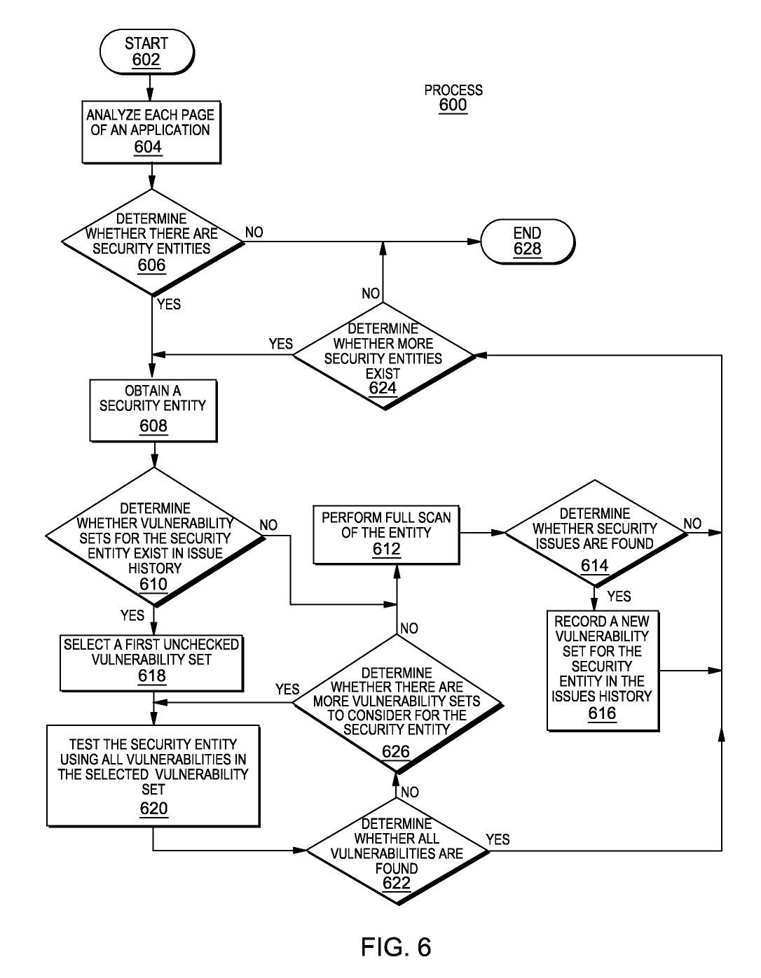

With reference to FIG. 6 a flowchart of a process using the security scan system of FIG. 3 in accordance with one embodiment of the disclosure is presented. Process 600 is another example embodiment of a security scan of an application using security scan system 216 of FIG. 4.

Process 600 begins (step 602) and analyzes each page of an application (step 604). A most time consuming task is to perform a full scan on an entity. Consider that the entity located may appear in multiple pages, and for each page, the entity will have to be fully tested. Therefore the disclosed process typically minimizes the number of times that a security entity is fully tested by reusing knowledge across pages of the security issues associated with the particular entity, and recording those issues into a data structure containing vulnerability sets.

Process 600 determines whether there are security entities, on the pages being analyzed (step 606). Responsive to a determination that there are no more entities (step 606, NO branch), process 600 terminates (step 628). Responsive to a determination that there are security entities (step 606, YES branch), process 600 obtains a next security entity (step 608). A security entity is a generic reference representative of each security entity in a set of entities located during analysis of the page.

Using the security entity, process 600 determines whether vulnerability sets for the security entity exists in an issue history (step 610). The issue history is the previously recited data structure containing vulnerability sets. In an example, two different webpages are present in which each webpage has entity A present. On one of the two pages entity A is vulnerable to a vulnerability {X, Y, Z} and on the other page entity A is vulnerable to {X, W, K}. The identification of the vulnerabilities during analysis of the webpages produces in the issue history data structure two vulnerability sets for entity A comprising a first vulnerability set of {X, Y, Z} and a second vulnerability set {X, W, K}. The order or relative numbering is not important for the operation of the disclosed process. Whenever entity A is encountered again the entity will be tested first to determine whether the entity is vulnerable to either one of {X, Y, Z} and {X, W, K} sets. When the entity is found vulnerable, the testing on that entity for that particular page stops. When found not vulnerable (none of the vulnerability sets for that entity recorded in the issue history match) then a full scan of entity A for the particular page is triggered.

Responsive to a determination that no security entities found (step 610, NO branch), process 600 performs a full scan of the security entity (step 612). However, responsive to a determination that vulnerability sets for the security entity exist in the issue history (step 610, YES branch), process 600 selects a first unchecked vulnerability set (step 618) and tests the security entity using all vulnerabilities in the selected vulnerability set (step 620). Testing involves sending all security tests used in this selected vulnerability set to discover these vulnerabilities associated with the entity. Sending of the tests in this instance is typically several orders of magnitude lower than sending all security tests, because while there are typically thousands of security tests process 600 only needs to send a limited number of specific tests.

Process 600 determines whether all vulnerabilities are found (step 622). In response to a determination that all vulnerabilities are found (step 622, YES branch), process 600 stops testing the current security entity and determines whether more security entities exist (step 624). Responsive to a determination that more security entities exist (step 624, YES branch), process 600 returns to step 608 as before and obtain a next security entity. The subset of process 600 is repeated until either a full match of vulnerabilities is achieved or all vulnerability sets have been considered.

However, in response to a determination that not all vulnerabilities are found (step 622, NO branch), process 600 determines whether there are more vulnerability sets to consider for the security entity (step 626). Responsive to a determination that there are more vulnerability sets to consider for the security entity (step 626, YES branch), process 600 returns to perform step 620 as before. Responsive to a determination that there are no more vulnerability sets to consider for the security entity (step 626, NO branch), process 600 performs a full scan of the security entity (step 612) as before.

Returning to step 612, upon completion of the full vulnerability scan, process 600 determines whether security issues are found (step 614). In response to a determination that security issues were found (step 614, YES branch), process 600 records the new vulnerability set identified for the current instance of the security entity in the issues history (step 616). Process 600 returns to perform step 624 as before. In response to a determination that security issues were not found (step 614, NO branch), process 600 returns to perform step 624 as before. Responsive to a determination that no more security entities exist (step 624, NO branch), process 600 terminates (step 628).

In an alternative embodiment, process 600 tests all vulnerability sets recorded in the issues history for security entity, although a single vulnerability test might have matched a current vulnerability set. This form of extended testing can be used to eliminate false negatives that could occur when the issues history contains sets of vulnerabilities that are subsets of other vulnerability sets. For example, using vulnerability set of {X, Y} and vulnerability set of {X, Y, Z} for a particular security entity A when testing is stopped after a vulnerability set of {X, Y} with a positive match, process 600 might miss reporting on vulnerability Z (when the security entity A on the particular page is vulnerable to the vulnerability set of {X, Y, Z}).

Thus, is presented, in an illustrative embodiment, a computer-implemented process for security scanning using entity history. The computer-implemented method determines whether a set of vulnerabilities exist for a selected security entity and responsive to a determination that the set of vulnerabilities exist for the selected security entity, tests the selected security entity using a vulnerability set selected from an issues history.

The computer-implemented method further determines whether all vulnerabilities are found and responsive to a determination that all vulnerabilities are not found, determines whether more vulnerabilities sets exist. Responsive to a determination that more vulnerabilities sets exist, obtains a next set of vulnerabilities and tests the selected security entity using another vulnerability set selected from the issues history.

Responsive to a determination that a set of vulnerabilities does not exist for the selected security entity, performs a full scan of the selected security entity and determines whether security issues are identified. Responsive to a determination that security issues are identified, the computer-implemented method records the security issues identified in the issues history.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable data storage device having computer executable instructions stored thereon in a variety of forms. Examples of computer readable data storage devices include recordable-type media, such as a floppy disk, a hard disk drive, a RAM, CD-ROMs, DVD-ROMs. The computer executable instructions may take the form of coded formats that are decoded for actual use in a particular data processing system.

A data processing system suitable for storing and/or executing computer executable instructions comprising program code will include one or more processors coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A computer-implemented method for security scanning using entity history, the computer-implemented method comprising:
determining, by one or more processors, whether a set of vulnerabilities exist for a selected security entity;
responsive to a determination that the set of vulnerabilities exist for the selected security entity, testing, by one or more processors, the selected security entity using a vulnerability set selected from an issues history;
determining, by one or more processors, whether all vulnerabilities are found;
responsive to a determination that all vulnerabilities are not found, determining, by one or more processors, whether more vulnerabilities sets exist;
responsive to a determination that more vulnerabilities sets exist, obtaining, by one or more processors, a next set of vulnerabilities;
testing, by one or more processors, the selected security entity using another vulnerability set selected from the issues history;
responsive to a determination that a set of vulnerabilities does not exist for the selected security entity, performing, by one or more processors, a full scan of the selected security entity;
determining, by one or more processors, whether security issues are identified; and
responsive to a determination that security issues are identified, recording, by one or more processors, the security issues identified in the issues history.

2. The computer-implemented method of claim 1, wherein determining whether a set of vulnerabilities exist for a selected security entity further comprises:
determining, by one or more processors, whether there are more pages associated with an application;
analyzing, by one or more processors, a next page obtained using an entity locator;
determining, by one or more processors, whether there are more entities; and
responsive to a determination that there are more entities, obtaining, by one or more processors, a next entity.

3. The computer-implemented method of claim 1, wherein responsive to a determination that a set of vulnerabilities exist for a selected security entity, testing the selected entity using a vulnerability set selected from an issues history further comprises:
selecting, by one or more processors, a first unchecked vulnerability set;
testing, by one or more processors, the security entity using all vulnerabilities in the vulnerability set selected;
determining, by one or more processors, whether all vulnerabilities are found;
responsive to a determination that all vulnerabilities are found, determining, by one or more processors whether more security entities exist; and
responsive to a determination that there are no more entities, terminating, by one or more processors, testing of the selected entity.

4. The computer-implemented method of claim 1, wherein determining whether vulnerability sets for the security entity exist in an issues history further comprises:
responsive to a determination that vulnerability sets for the security entity do not exist in an issues history, performing, by one or more processors, a full scan of the security entity.

5. The computer-implemented method of claim 4, wherein performing a full scan of the security entity further comprises:
determining, by one or more processors, whether issues were found; and
responsive to a determination that issues are found, recording, by one or more processors, a new vulnerability set for the security entity in the issues history.

6. The computer-implemented method of claim 1, wherein testing the security entity using all vulnerabilities in the vulnerability set selected further comprises:
sending, by one or more processors, all security tests used in the vulnerability set selected to discover vulnerabilities associated with the security entity.

7. The computer-implemented method of claim 1, wherein responsive to a determination that all vulnerabilities are found further comprises:
testing, by one or more processors, all vulnerability sets recorded in the issues history, including associated subsets, associated with the security entity, to eliminate a false negative result when the set of vulnerabilities is a subset of another set of vulnerabilities in the issues history.

8. A computer program product for security scanning using entity history, the computer program product comprising:
a computer readable storage device containing computer executable program code stored thereon, the computer executable program code comprising:
computer executable program code for determining whether a set of vulnerabilities exist for a selected security entity;
computer executable program code that responds to a determination that the set of vulnerabilities exist for the selected security entity by testing the selected entity using a vulnerability set selected from an issues history;
computer executable program code for determining whether all vulnerabilities are found;
computer executable program code that responds to a determination that all vulnerabilities are not found by determining whether more vulnerabilities sets exist;
computer executable program code that responds to a determination that more vulnerabilities sets exist by obtaining a next set of vulnerabilities;
computer executable program code for testing the selected security entity using another vulnerability set selected from the issues history;
computer executable program code that responds to a determination that a set of vulnerabilities does not exist for a selected security entity by performing a full scan of the selected security entity;
computer executable program code for determining whether security issues are identified; and
computer executable program code that responds to a determination that security issues are identified by recording the security issues identified in the issues history.

9. The computer program product of claim 8, wherein computer executable program code for determining whether a set of vulnerabilities exist for a selected security entity further comprises:
computer executable program code for determining whether there are more pages associated with an application;
computer executable program code for analyzing a next page obtained using an entity locator;
computer executable program code for determining whether there are more entities; and
computer executable program code that responds to a determination that there are more entities by obtaining a next entity.

10. The computer program product of claim 8, wherein computer executable program code that responds to a determination that a set of vulnerabilities exist for a selected security entity by testing the selected entity using a vulnerability set selected from an issues history further comprises:
computer executable program code for selecting a first unchecked vulnerability set;
computer executable program code for testing the security entity using all vulnerabilities in the vulnerability set selected;
computer executable program code for determining whether all vulnerabilities are found;
computer executable program code that responds to a determination that all vulnerabilities are found by determining whether more security entities exist; and
computer executable program code to respond to a determination that there are no more entities by terminating testing of the selected entity.

11. The computer program product of claim 8, wherein computer executable program code for determining whether vulnerability sets for the security entity exist in an issues history further comprises:
computer executable program code that responds to a determination that vulnerability sets for the security entity do not exist in an issues history by performing a full scan of the security entity.

12. The computer program product of claim 11, wherein computer executable program code for performing a full scan of the security entity further comprises:
computer executable program code for determining whether issues were found; and
computer executable program code that responds to a determination that issues are found by recording a new vulnerability set for the security entity in the issues history.

13. The computer program product of claim 8, wherein computer executable program code for testing the security entity using all vulnerabilities in the vulnerability set selected further comprises:
computer executable program code for sending all security tests used in the vulnerability set selected to discover vulnerabilities associated with the security entity.

14. The computer program product of claim 8, wherein computer executable program code that responds to a determination that all vulnerabilities are found further comprises:
computer executable program code for testing all vulnerability sets recorded in the issues history, including associated subsets, associated with the security entity, to eliminate a false negative result when the set of vulnerabilities is a subset of another set of vulnerabilities in the issues history.

15. A computer system for security scanning using entity history, the computer system comprising:
one or more computer processors;
one or more computer readable storage medium;
computer executable program code stored on the computer readable storage medium for execution by at least one of the one or more processors, the computer executable program code comprising:
computer executable program code for determining whether a set of vulnerabilities exist for a selected security entity;
computer executable program code that responds to a determination that the set of vulnerabilities exist for the selected security entity by testing the selected entity using a vulnerability set selected from an issues history;
computer executable program code for determining whether all vulnerabilities are found;
computer executable program code that responds to a determination that all vulnerabilities are not found by determining whether more vulnerabilities sets exist;
computer executable program code that responds to a determination that more vulnerabilities sets exist by obtaining a next set of vulnerabilities;
computer executable program code for testing the selected security entity using another vulnerability set selected from the issues history;
computer executable program code that responds to a determination that a set of vulnerabilities does not exist for a selected security entity by performing a full scan of the selected security entity;
computer executable program code for determining whether security issues are identified; and
computer executable program code that responds to a determination that security issues are identified by recording the security issues identified in the issues history.

16. The apparatus of claim 15, wherein computer executable program code for determining whether a set of vulnerabilities exist for a selected security entity further comprises:
computer executable program code for determining whether there are more pages associated with an application;
computer executable program code for analyzing a next page obtained using an entity locator;
computer executable program code for determining whether there are more entities; and
computer executable program code that responds to a determination that there are more entities by obtaining a next entity.

17. The apparatus of claim 15, wherein computer executable program code that responds to a determination that a set of vulnerabilities exist for a selected security entity by testing the selected entity using a vulnerability set selected from an issues history further comprises:
computer executable program code for selecting a first unchecked vulnerability set;
computer executable program code for testing the security entity using all vulnerabilities in the vulnerability set selected;
computer executable program code for determining whether all vulnerabilities are found;
computer executable program code that responds to a determination that all vulnerabilities are found by determining whether more security entities exist; and computer executable program code to respond to a determination that there are no more entities by terminating testing of the selected entity.

18. The apparatus of claim 15, wherein computer executable program code for determining whether vulnerability sets for the security entity exist in an issues history further comprises:
computer executable program code that responds to a determination that vulnerability sets for the security entity do not exist in an issues history by performing a full scan of the security entity.

19. The apparatus of claim 18, wherein computer executable program code for performing a full scan of the security entity further comprises:
computer executable program code for determining whether issues were found; and
computer executable program code that responds to a determination that issues are found by recording a new vulnerability set for the security entity in the issues history.

20. The apparatus of claim 15, wherein computer executable program code for testing the security entity using all vulnerabilities in the vulnerability set selected further comprises:
computer executable program code for sending all security tests used in the vulnerability set selected to discover vulnerabilities associated with the security entity.
